(19) United States
(12) Patent Application Publication
(10) Pub. No.: US 2014/0310203 A1
(43) Pub. Date: Oct. 16, 2014

(54) EQUITY BASED INCENTIVE COMPENSATION PLAN

(71) Applicant: Raymond B. Ryan, Darien, CT (US)

(72) Inventor: Raymond B. Ryan, Darien, CT (US)

(21) Appl. No.: 14/253,845

(22) Filed: Apr. 15, 2014

Related U.S. Application Data
(60) Provisional application No. 61/812,492, filed on Apr. 16, 2013.

(51) Int. Cl. G06Q 40/06

(52) U.S. Cl. CPC G06Q 40/06
USPC 705/36 R

(57) ABSTRACT

The present invention extends to methods, systems, and computer program products for an Equity Based Incentive Compensation (EBIC) plan. In an EBIC plan, a company awards restricted shares of their stock to employees as incentive compensation. The restricted shares are transferred to a separate holding vehicle. Loans are provided to the holding vehicle by a third party lender. Loans are secured by a part or all of the employee' shares transferred to the separate holding vehicle. Employees may or may not elect to include their restricted shares as taxable income at award date. The holding vehicle uses loan proceeds to reimburse payroll withholdings for employees electing to include their restricted shares as taxable income at award date or to buy additional unrestricted shares of the company's stock. Upon vesting of the restricted shares, one or more unrestricted shares are sold for loan repayment and/or to satisfy further tax liabilities.

### CROSS-REFERENCE TO RELATED APPLICATIONS

This application claims the benefit of and priority to United States Provisional Patent Application Ser. No. 61/812,492, entitled “Equity Based Incentive Compensation Plan”, filed Apr. 16, 2013 by Raymond B. Ryan, the entire contents of which are expressly incorporated by reference.

### BACKGROUND

1. Background and Relevant Art

There are primarily two types of equity-based compensation programs used by public corporations: Restricted Stock Awards (“RSAs”) and non-qualified stock options (“NQSOs”). These programs effectively encourage employee-participants to sell awarded shares as soon as the participant is permitted to do so. RSA participants are taxed on the entire stock award's fair market value at the time of the vesting of the award, at ordinary income tax rates. NQSO participants are required to pay the option price (typically, the shares' grant date fair market value) at the time of the exercise of the option, and are subject to tax at ordinary income tax rates for the exercise date appreciation in the value of the shares over the option price.

Many shareholder advocates and economists have espoused the view that the interests of businesses and their constituents are best served when a company's compensation structure aligns the long-term interests of the company's executives and other employees with those of the company's investor shareholders. However, with both RSAs and NQSOs there is a tax-based incentive to sell awarded shares. Thus, in both cases, employee participants commonly sell much, if not all, of their restricted stock or NQSO award shares, to pay the tax due and to generate residual cash.

The Sarbanes-Oxley Act, section 402 (“SOX section 402”) provides as follows:
It shall be unlawful for any issuer . . . , directly or indirectly, including through an subsidiary, to extend or maintain credit, to arrange for the extension of credit, or to renew an extension of credit, in the form of a personal loan to or for any director or executive officer (or equivalent thereof) of that issuer.

By its terms, SOX section 402 prohibits an issuer (directly or indirectly) from extending credit, maintaining credit, or arranging for the extension of credit, where such credit is in the form of a personal loan to or for a company's director or a senior executive. As such, a company funded equity-based compensation programs must not extend credit to or arrange for the extension of credit to directors or “executive officers”. SOX 402 does not expressly define “executive officers”. However, it is widely held that executive officers is a subset of the group described in section 16 of the Securities Exchange Act of 1934 (i.e., SOX section 403).

### BRIEF SUMMARY

The present invention extends to methods, systems, and computer program products for an Equity Based Incentive Compensation (“EBIC”) plan. In an EBIC plan, a company awards restricted shares of their stock to employees as incentive compensation (vesting conditions on restricted stock can be service, performance based, and/or time based. The restricted shares are transferred to a separate holding vehicle, such as, a restricted brokerage account, an independently managed employee grantor trust, a partnership, a managed account, a limited liability company, etc. Loans are provided to the holding vehicle by a third party lender, such as, for example, an independent bank or similar lending institution. Loans are secured by some or all of the employee-participants' shares transferred to the separate holding vehicle. Employees may or may not elect to include their restricted shares as taxable income at award date instead of a defined vesting date.

Thus, in some embodiments, the holding vehicle uses loan proceeds to reimburse payroll withholdings for employees electing to include their restricted shares as taxable income at the award date. In other embodiments, the holding vehicle uses loan proceeds to buy additional unrestricted shares of the company's stock. Upon vesting of the restricted shares, one or more unrestricted shares are sold for loan repayment and/or to satisfy further tax liabilities. Accordingly, an EBIC plan may enable and motivate employee-participants to hold award shares (possibly well) past their vesting date. Further, even though loans are issued, EBIC plans maintain compliance with Regulation U of Title 12, Banks & Banking of the Code of Federal Regulations and with Section 13(k) of Securities Exchange Act of 1934 regarding loans to Directors and Senior Executives of a public company.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates establishing an Equity Based Incentive Compensation (“EBIC”) plan.

FIG. 2 illustrates a flowchart of an example method for establishing an Equity Based Incentive Compensation (“EBIC”) plan.

FIG. 3 illustrates an example computer architecture that facilitates establishing an alternative Equity Based Incentive Compensation (“EBIC”) plan.

FIG. 4 illustrates a flowchart of an example method for establishing an alternative Equity Based Incentive Compensation (“EBIC”) plan.

### DETAILED DESCRIPTION

The present invention extends to methods, systems, and computer program products for an Equity Based Incentive Compensation (“EBIC”) plan. In an EBIC plan, a public company (which can also be referred to as the “plan sponsor”, “employer”, “corporation” or “issuer”) awards restricted shares of their stock to employees as incentive compensation (stock restrictions can be one or more of: service based, performance based, and market based . The restricted shares are transferred to a separate holding vehicle, such as, a restricted brokerage account, an independently managed employee grantor trust, a partnership, a managed account, a limited liability company, etc. (the “holding vehicle”) Loans are provided to the holding vehicle by a third party lender, such as, for example, an independent bank or similar lending institution. Loans are secured by some or all of the employee-participants' shares transferred to the separate holding vehicle. Employees may or may not elect to include their restricted shares as taxable income at award date.

Thus, in some embodiments, the holding vehicle uses loan proceeds to reimburse payroll withholdings for employees electing to include their restricted shares as taxable income at the award date. In other embodiments, the holding vehicle uses loan proceeds to buy additional unrestricted shares of the company's stock. Upon vesting of the restricted shares, one or more unrestricted shares are sold for loan repayment and/or to satisfy further tax liabilities. Accordingly, an EBIC plan may enable and motivate employee-participants to hold award shares past their vesting date. Further, even though loans are issued, EBIC plans maintain compliance with Regulation U of Title 12, Banks & Banking of the Code of Federal Regulations and with Section 13(k) of Securities Exchange Act of 1934 regarding loans to Directors and Senior Executives of a public company.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, and both perform tasks. In a distributed system environment, program modules may be located in both local and remote memory storage devices.

Embodiments of the invention can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

Embodiments of the invention provide an Equity Based Incentive Compensation (“EBIC”) plan. An EBIC plan design can include awarding restricted shares of stock to eligible employees as a form of incentive compensation. Vesting conditions on restricted shares of stock can be service based, performance based, market based, or some combination of these restrictions. In some embodiments, an employee/participant elects to include their restricted shares as taxable income at award date. A qualified election can be made within a specified number of days prior to or following the award. In these embodiments, the restricted stock award may have a tax withholding beginning at the share award date.

For example, an EBIC plan can create sufficient incidence of employee ownership in the awarded restricted shares under applicable provisions of the Internal Revenue Code or a qualifying employee election. As such, employee/participants report the value of the stock award as taxable income as of the award grant date, rather than on the date of vesting. As such, the restricted shares tax basis is the share value at the grant date and the holding period (e.g., for determining long term capital gains) also begins at the grant date.

Under an EBIC plan, employee-participants transfer restricted shares received as incentive compensation to a separate holding vehicle, such as, a restricted brokerage account, an independently managed employee grantor trust, a partnership, a managed account, a limited liability company. Thus, a trust is one type holding vehicle. A trust can be administered by an independent trustee that is obligated to follow provisions of a trust agreement. Plan assets and liabilities, such as, for example, restricted stock, non-restricted stock, and (e.g., non-recourse) debt can be held in trust to be governed by the terms of a written plan. Employee-participants have no control over the trustee, the trust, its assets, or its obligations.

A trust agreement directs the trustee to borrow funds via term loans from an independent third party lender (e.g., a bank), using some of all of the shares transferred to the trust as collateral and recourse to trust held assets. The loans can be non-recourse loans. Thus, a third party lender may have no recourse beyond the pledged shares. Because loans are not provided by a broker-dealer they are not subject to the margin rules of Regulation T (12 CFR, section 220). Instead, margin rules of Regulation U apply to the third party lender.

Thus, the trust agreement can direct a trustee to use the borrowed funds to make a distribution to the beneficiaries (or to the employer to reimburse for the tax withholding requirement) in an amount approximately equal to (or less than) the tax incurred as a result of the award share grant. Any appreciation in the value of the stock after the grant date is not taxable at vesting or upon distribution of shares from the trust to the employee/participant. Rather, appreciation after grant date is taxed in the event of a future sale of the shares by the employee/participant. That is, the shares are taxed as taxed as capital gains and not as ordinary income.

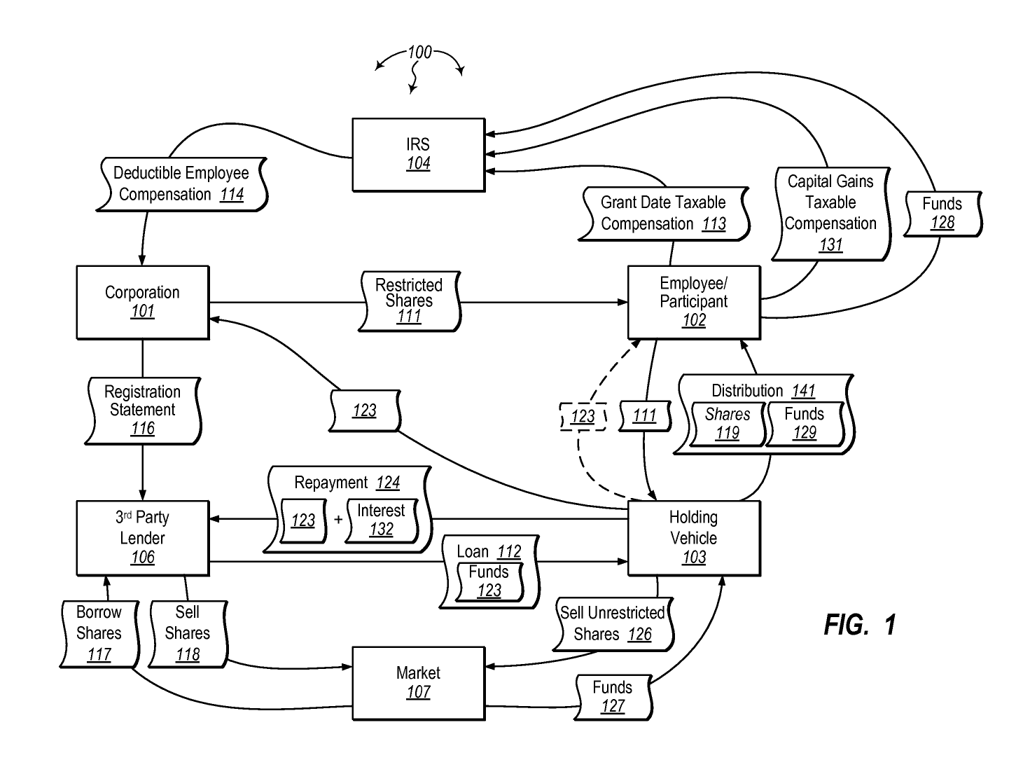

FIG. 1 illustrates an example computer architecture 100 that facilitates establishing an Equity Based Incentive Compensation (“EBIC”) plan. As depicted, architecture 100 includes corporation 101, employee/participant 102, holding vehicle 103 (e.g., an EBIC trust), Internal Revenue Service (“IRS”) 104, 3^{rd} party lender 106, and market 107 (e.g., a public stock exchange).

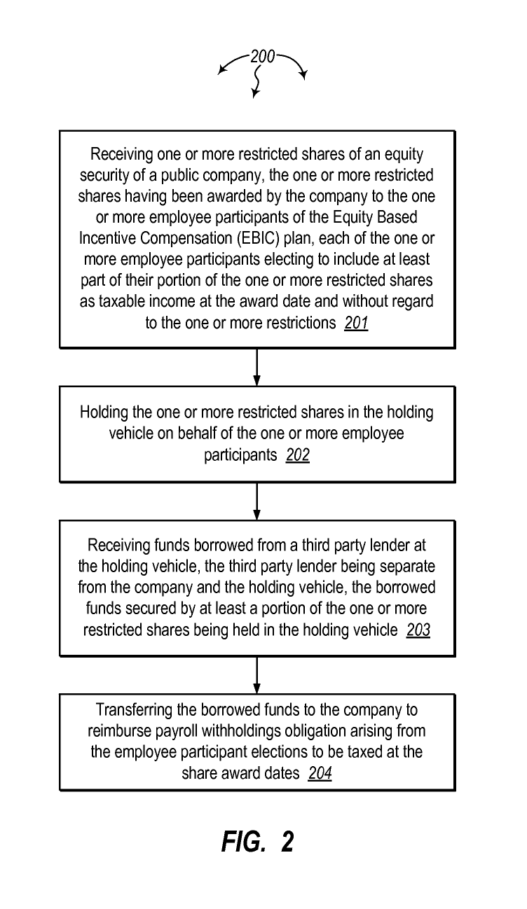

FIG. 2 illustrates a flowchart of an example method 200 for establishing an Equity Based Incentive Compensation (“EBIC”) plan. Method 200 will be described with respect to the components and data of computer architecture 100.

In general, corporation 101 can award restricted shares to one or more employee/participants in an EBIC stock award plan which includes a loan option for SOX directors and/or executive officers. The loan terms are SOX compliant as set forth in the U.S. Securities and Exchange Commission letter attached as Appendix A. Depending on plan terms, EBIC in a stock award plan can be optional or mandatory for non-SOX employees. An EBIC option for non-SOX employees can also contain features prohibited to SOX directors and executive officers.

To continue the example, corporation 101 can award restricted shares 111 to employee/participant 102.

Method 200 includes receiving one or more restricted shares of the equity security of the public company, the one or more restricted shares having been awarded by the company to the one or more employee/participants of the Equity Based Incentive Compensation (EBIC) plan, each of the one or more employee/participants electing to include their portion of the one or more restricted shares as taxable income at the award date and without regard to the one or more restrictions (201). For example, employee/participant 102 can receive restricted shares 111 from corporation 101. Employee/participant 102 can make an Internal Revenue Code (“IRC”) section 83(b) or similar election upon award of restricted shares 111 from corporation 101. Based on employee/participant 102 electing to treat restricted shares 111 as current year taxable income, grant date taxable compensation 113 is reported to IRS 104. Grant date taxable compensation 113 can be the market value (ignoring the restrictions effect on value) of the restricted shares 111 at time of grant. Correspondingly, corporation 101 is able to deduct employee compensation 114 reported to IRS 104. Deductible employee compensation 114 is equal to the value of restricted shares 111 reported as income by employee/participant 102.

Method 200 includes holding the one or more restricted shares in the holding vehicle on behalf of the one or more employee/participants (202). For example, holding vehicle 103 (e.g., a trust) can hold restricted shares 111. Holding vehicle 103 can hold shares in accordance with a written (e.g., trust) agreement. Employee/participant 102 has no control of the administrator of holding vehicle 103.

Method 200 includes receiving funds borrowed from a third party lender at the holding vehicle, the third party lender being separate from the company and the holding vehicle, the borrowed funds secured by at least a portion of the one or more restricted shares being held in the holding vehicle (203). For example, a written EBIC plan can direct an administrator of holding vehicle 103 to borrow funds from 3^{rd} party lender 106 (e.g., a bank). In response, 3^{rd} party lender 106 can create loan 112 for holding vehicle 103. 3^{rd} party lender 106 can transfer funds 123 (or the loan principal) to holding vehicle 103. Holding vehicle 103 can receive funds 123 from 3^{rd} party lender 106. The amount of funds 123 can be approximately equal to or less than the amount of tax incurred from grant date taxable compensation 113. Funds 123 can be secured by some or all of shares 111.

In some embodiments, 3^{rd} lender 106 makes loan 112 of 123 to holding vehicle 103. The amount of funds 123 can be equal to the value of some number shares of corporation 101 (e.g., 4 shares) secured by a larger number of restricted shares 111 (e.g., 8 shares) held by holding vehicle 103 (recourse to some or all of the assets of holding vehicle 103).

Method 200 includes transferring the borrowed funds to the company to reimburse payroll withholdings arising from the employee/participant elections to be taxed at the share award dates (204). For example, the written agreement can an administrator of holding vehicle 103, to use funds 123 to make a distribution to employee/participant 102 for estimated individual tax payments or to corporation 101 for tax withholding purposes (e.g., to satisfy some or all of the tax liability incurred from grant date taxable compensation 113).

Corporation 101 can also provide registration statement 116 to 3^{rd} party lender 106. Registration statement 116 can be for a number of shares equal to restricted shares 111. In turn, 3^{rd} party lender 106 borrows shares 117 (shares of corporation 101 up to the number of shares indicated in registration statement 116) from stock lenders in market 107. 3^{rd} party lender 106 also sells shares 118 (some portion or all of borrowed shares 117) in market 107 to hedge the value of loan 112.

In some embodiments, the functionality of 3^{rd} party lender 106 is divided between different parties. One party can issue a loan and another party can borrow shares and sell shares to hedge the value of the loan.

Subsequent to holding restricted shares 111 at holding vehicle 103, the vesting conditions associated with restricted shares 111 can be satisfied causing the restricted shares 111 to vest into unrestricted shares 126 and 119. Vesting of restricted shares 111 can also trigger repayment of loan 112. Holding vehicle 103 can then sell unrestricted shares 126 in market 107. The sale of unrestricted shares 126 can generate funds 127 being returned to holding vehicle 103.

A portion (and possibly the majority) of funds 127 can be used to repay loan 112. For example, repayment 124 in an amount equal to loan principal 123 plus interest 132 can be returned to 3^{rd} party lender 106. Funds 129 may be left over at least due to the price per share of corporation 101's stock not dividing evenly into loan principal 123+interest 132. For example, it may be that loan principal 123+interest 132 is $136 and a share of corporation 101's stock is valued at $100. Thus, two shares of stock are sold to satisfy repayment 124. After repayment 124, $64 is remaining from proceeds of the sale.

After loan 112 is repaid, holding vehicle 103 can make distribution 141 to employee/participant 102. Distribution 141 includes shares 119 (i.e., unrestricted shares not sold to repay loan 112) and funds 129.

Another embodiment of the loan repayment 124 is that the loan agreement enables holding vehicle to repay the loan 112 by delivery of shares 111 to the 3^{rd} party lender. This alternative will be exercised when the collateral share 111 value is less than the repayment 124 obligation. With a nonrecourse loan 112, the delivery of the shares 111 will extinguish the debt 112 and relieve the holding vehicle (or any other party) from any further obligations with respect to repayment 124.

Employee/participant 102 can report capital gains compensation 131 from the sale of unrestricted shares 126 to IRS 104. Capital gains taxable compensation 131 can be calculated from the difference in the share value of company 101's stock when awarded to employee/participant and the share value of company 101's stock when unrestricted shares 126 are sold. Employee/participant 102 can send funds 128 to IRS 104 to satisfy any tax liability associated with capital gains taxable compensation 131. Funds 128 can be generated from the sale of some or all of shares 119 or from other sources available to employee/participant 102. In some embodiments, holding vehicle 103 alternatively handles capital gains compensation reporting and any corresponding tax payment.

In other embodiments, there is not an election to accelerate taxation of the share award at grant date. In these other embodiments, vesting of award shares beings the holding period. The vesting date and the award share value is then taxable income to the employee/participant beneficiary. An EBIC (e.g., trust) agreement directs the trustee to borrow funds via term loans from an independent third party lender (e.g., a bank), using some of all of the shares transferred to the trust as collateral and recourse to some or all of the trust held assets. Recourse can be limited to the named assets in the trust.

Using a trust as a holding vehicle, the trust agreement can direct a trustee to use borrowed funds to purchase additional shares. The holding period begins on the purchase data and the cost basis is the purchase cost. While timing can vary, the maturity of the loan and the vesting data of the share award can coincide. The trust agreement (as an example) can direct the trustee, at the maturity of each loan, to sell sufficient shares to repay the loan, and to distribute the remaining shares and any residual cash to the employee-participants debt-free.

The value of the restricted award is taxable income equal to its value at the vesting date. The purchased shares are not affected by the vesting date. While there may be more tax (and more shares to sell) than under the above described plan, the purchased shares may be eligible capital gains treatment. When there is share appreciation from the grant date, the capital gains tax rate makes available more after tax cash to retire the debt obligation from a sale of some or all purchased shares. This extra cash arises because capital gains rates are less than ordinary income tax rates.

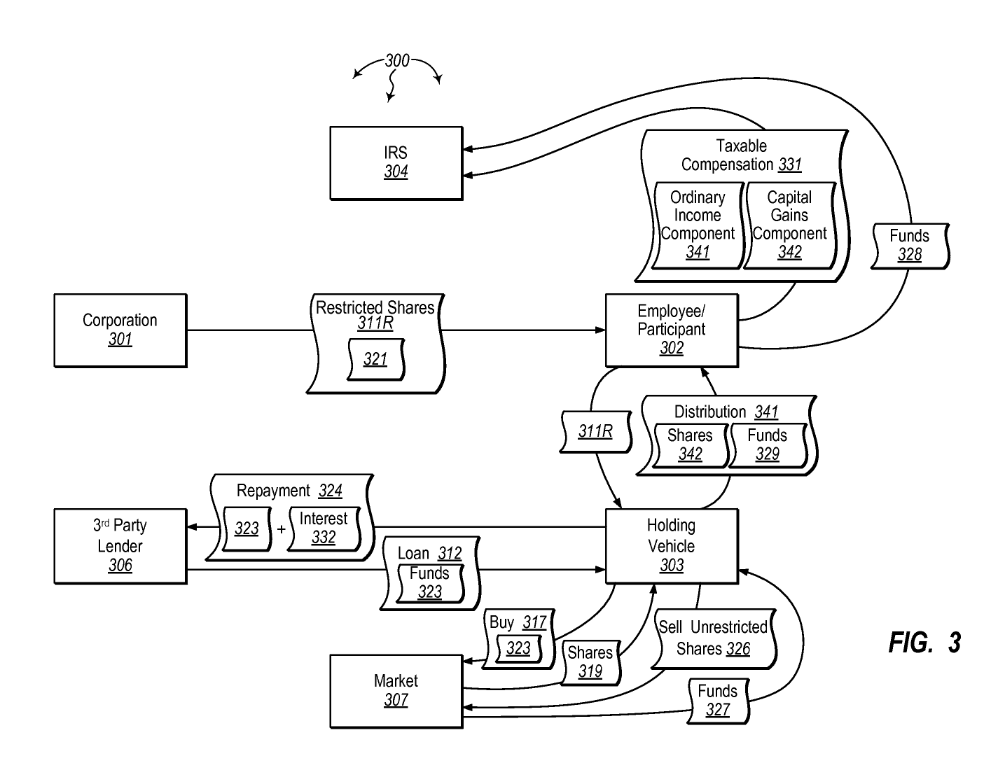

FIG. 3 illustrates an example computer architecture 300 that facilitates establishing an Equity Based Incentive Compensation (“EBIC”) plan. As depicted, architecture 300 includes corporation (issuer) 301, employee/participant 302, holding vehicle 303 (e.g., a trust), Internal Revenue Service (“IRS”) 304, 3^{rd} party lender 306, and market 307 (e.g., a public stock exchange).

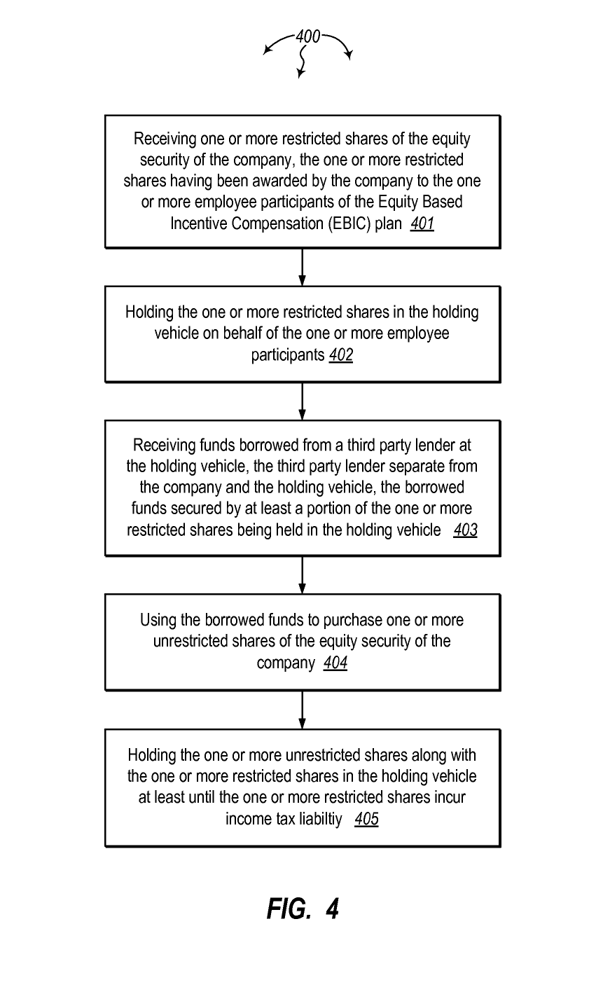

FIG. 4 illustrates a flowchart of an example method 400 for establishing an Equity Based Incentive Compensation (“EBIC”) plan. Method 400 will be described with respect to the components and data of computer architecture 300.

In general, corporation 301 can award restricted shares to one or more employee/participants in an EBIC plan. For example, corporation 301 can award restricted shares 311R to employee/participant 302. Method 400 includes receiving one or more restricted shares of the equity security of the company, the one or more restricted shares having been awarded by the company to the one or more employee/participants of the Equity Based Incentive Compensation (EBIC) plan (401). For example, employee/participant 302 can receive restricted shares 311R. Employee/participant 302 can send restricted shares 311R to holding vehicle 303. Holding vehicle 303 can receive restricted shares 311R from employee/participant 302.

Method 400 includes holding the one or more restricted shares in the holding vehicle on behalf of the one or more employee/participants (402). For example, holding vehicle 303 can hold restricted shares 311R. Holding vehicle 303 can hold restricted shares 311R in accordance with a written agreement. Participant/Employee 302 has no control of the administrator of holding vehicle 303.

Method 400 includes receiving funds borrowed from a third party lender at the holding vehicle, the third party lender separate from the company and the holding vehicle, the borrowed funds secured by at least a portion of the one or more restricted shares being held in the holding vehicle (403). For example, the written agreement can direct holding vehicle 303 to borrow funds from 3^{rd} party lender 306 (e.g., a bank). In response, 3^{rd} party lender 306 can create loan 312 for holding vehicle 303. 3^{rd} party lender 306 can transfer funds 323 (the loan principal) to holding vehicle 303. Holding vehicle 303 can receive funds 323 from 3^{rd} party lender 306. The amount of funds 323 can be as large an amount that can be legally secured by the shares held and to be purchased at holding vehicle 303. Funds 323 can be secured at least by additional purchased shares 319 (and possibly also some or all of restricted shares 311R).

Method 400 includes using the borrowed funds to purchase one or more unrestricted shares of the equity security of the company in the market (404). For example, holding vehicle can submit buy 317 to market 307. Buy 317 uses funds 323 to buy a number of unrestricted shares of corporation 301 equal in value to funds 323. Holding vehicle can obtain shares 319 (of corporation 301) from the submission of buy 317. In other embodiments, shares can be purchased directly from the issuer or another private party.

Method 400 includes holding the one or more unrestricted shares along with the one or more restricted shares in the holding vehicle at least until the one or more restricted shares incur income tax liability(405). For example, holding vehicle 301 can hold shares 319 along with restricted shares 311R at holding vehicle 303. Holding vehicle 301 can hold shares 319 along with restricted shares 311R at least until restricted shares 311R vest.

Subsequent to holding restricted shares 311R at holding vehicle 303, the vesting conditions associated with restricted shares 311R can be satisfied causing the restricted shares 311R to vest into unrestricted shares 311U. Vesting of restricted shares 311R can also trigger repayment of loan 312. Holding vehicle 303 can then sell unrestricted shares 326 (including a portion of one or more both of shares 311U and 319). The sale of unrestricted shares 326 can generate funds 327 being returned to holding vehicle 303.

A portion of funds 327 can be used to repay loan 312. As described, funds 329 may be left over at least due to the price per share of corporation 301's stock not dividing evenly into loan principal 323+interest 332. After loan 312 is repaid, holding vehicle 303 can make distribution 341 to employee/participant 302. Distribution 341 includes shares 342 (i.e., remaining unrestricted shares from among shares 311U and shares 319 not sold to repay loan 312) and funds 329.

Another embodiment of the loan repayment 324 is that the loan agreement enables holding vehicle to repay the loan 312 by delivery of shares 321 and 319 to the 3^{rd} party lender. This alternative will be exercised when the collateral share 321 and 319 value is less than the repayment 324 obligation. With a nonrecourse loan 312, the delivery of the shares 321 and 319 will extinguish the debt 312 and relieve the holding vehicle (or any other party) from any further obligations with respect to repayment 324.

Employee/participant 302 can report taxable compensation 331 to IRS 104. Taxable compensation 331 can include ordinary income component 341 and capital gains component 342. Ordinary income component 341 can be calculated for shares 311U based on the share value of company 301's stock when shares 311R vested. Capital gains component 342 can be calculated for shares 319 by subtracting the share value of company 301's stock when shares 319 where purchased from the share value of company 301's stock when shares 319 are sold and multiplying the difference times the number of shares sold.

Employee/participant 302 can send funds 328 to IRS 304 to satisfy tax liability associate with taxable compensation 331. Funds 328 can be generated from the sale of some or all of shares 342 or from other sources available to employee/participant 302. In some embodiments, holding vehicle 303 alternatively handles taxable compensation reporting and any corresponding tax payment.

Thus, EBIC employee/participants have little, if any, financial incentive to cash in all their vested award shares after distribution by a holding vehicle. Indeed, the employee/participant is incentivized to hold shares since he or she receives the shares as debt free shares. The participant's tax holding period for purchased shares includes the period that the shares were held in a holding vehicle (e.g., trust), helping ensure long-term capital gains tax treatment whenever the shares are eventually sold by the participant. Using capital gains shares to pay tax on restricted stock awards and to repay the loan, enables the participant/employee hold more shares after vesting than where an EBIC strategy is not employed.

For SOX directors and senior executives (“Executives”), an employer-issuer has merely ministerial involvement in the loan from the third party lender to the holding vehicle (e.g., a trust managed by a trustee). Further, the issuer may not reimburse the EBIC Executive for his or her income taxes payable on the value of the shares received from the issuer or reimburse the Executive for interest or principal on the loan. The issuer can perform ministerial acts to facilitate Executive participation in the EBIC plan. For example, the issuer can deliver the share awards to the trust pursuant to the EBIC plan, provide the trustee and the lending institution with information regarding the Executive participants and the stock award, and deliver to the lending institution a prospectus and registration statement with respect to shares under the EBIC plan.

As such, EBIC programs can be implemented that do not involve a loan extended or arranged by the issuer. Instead loans are provided by independent banking institutions. The corporation merely has ministerial interaction with the trustee.

When non-Executive employees are participants in an EBIC plan that plan can include additional employee compensation such as income tax reimbursement, loan interest subsidies, principal guarantees, etc.

Modules, algorithms, components, etc., depicted in data flow 100 can be connected to one another over (or be part of) a network, such as, for example, a Local Area Network (“LAN”), a Wide Area Network (“WAN”), and even the Internet. Accordingly, the modules, algorithms, components, etc., depicted in data flow 100 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, the computer system including one or more processors, the computer system enabling an independent holding vehicle to perform obligations under an Equity Based Incentive Compensation (EBIC) plan being sponsored by a public company with its shares traded on a public stock exchange, the holding vehicle configured to independently hold employer awarded restricted shares of equity securities of the public company, the public company having granted the restricted shares to one or more employee/participants of the Equity Based Incentive Compensation (EBIC) plan, the restricted shares having one or more restrictions, a method, implemented by the one or more processors, for establishing the Equity Based Incentive Compensation (EBIC) plan and maintaining compliance with Regulation U of Title 12, Banks & Banking of the Code of Federal Regulations and with Section 13(k) of Securities Exchange Act of 1934 regarding loans to Directors and Senior Executives of the public company, the method comprising the one or more processors:
receiving one or more restricted shares of the equity security of the public company, the one or more restricted shares having been awarded by the company to the one or more employee/participants of the Equity Based Incentive Compensation (EBIC) plan, each of the one or more employee/participants electing to include all or a portion of their portion of the one or more restricted award shares as taxable income at the award date and without regard to the one or more restrictions;
holding the one or more restricted shares in the holding vehicle on behalf of the one or more employee/participants;
receiving funds borrowed from a third party lender at the holding vehicle, the third party lender being separate from the company and the holding vehicle, the borrowed funds secured by at least a portion of the one or more restricted shares being held in the holding vehicle; and
transferring the borrowed funds to the company to reimburse payroll withholdings obligation arising from the employee/participant elections to be taxed at the share award date.

2. The method of claim 1, further comprising detecting the vesting of one or more restricted shares of an employee/participant and wherein the share restrictions lift and the one or more shares become unrestricted, the vesting in accordance with a vesting service schedule, the vesting occurring after the employee/participant having elected to include the employee/participant's portion of the one or more restricted shares as taxable income.

3. The method of claim 2, wherein the borrowed funds originate from a loan from the third party lender, the loan corresponding to the employee/participant's portion of the one or more restricted shares, and further comprising:
receiving a loan repayment amount for the loan, the loan repayment amount including a principal loan repayment amount and an accrued interest repayment amount.

4. The method of claim 3, wherein a loan term ends on or about the date vesting occurs for the collateral shares for the loan such that repayment of the loan repayment amount is triggered when the employee/participant's portion of the one or more restricted shares vests.

5. The method claim 3, further comprising:
receiving proceeds from selling at least one of the one more unrestricted shares in the market; and
transferring at least a portion of the proceeds from the holding vehicle to the third party lender to repay the loan repayment amount.

6. The method of claim 5, further comprising:
calculating a long term capital gains income tax liability for the employee/participant and thereby the number of shares needed to sell to retire the debt obligation and fund the tax obligation, the long term capital gains income tax liability calculated based on the difference in the value of a share of the equity security at vesting and the value of a share of the equity security at award; and
using at least a portion of the proceeds to satisfy the income tax liability in addition to the loan obligation.

7. The method of claim 6, further comprising calculating an ordinary income tax liability for the employee/participant in response to the employee/participant electing to include the employee/participant's portion of the one or more restricted shares as taxable income at the award date; and
wherein transferring the borrowed funds to the company to reimburse its payroll withholdings obligation comprises transferring the borrowed funds to the company to satisfy at least part of the ordinary income tax liability for the employee/participant.

8. The method of 5, further comprising:
receiving further proceeds from selling remaining shares of the one more unrestricted shares in the market; and
distributing the further proceeds from the holding vehicle to the employee/participant.

9. The method of claim 1, wherein the holding vehicle is one of: a trust, a restricted brokerage account, a partnership, a managed account, or a limited liability company.

10. At a computer system, the computer system including one or more processors, the computer system enabling an independent holding vehicle to perform obligations under an Equity Based Incentive Compensation (EBIC) plan being sponsored by company, the holding vehicle configured to independently hold employer awarded restricted shares of equity securities of the company, the company having granted the restricted shares to one or more employee/ participants of the Equity Based Incentive Compensation (EBIC) plan, the restricted shares having one or more restrictions, a method, implemented by the one or more processors, for establishing the Equity Based Incentive Compensation (EBIC) plan and maintaining compliance with Regulation U of Title 12, Banks & Banking of the Code of Federal Regulations and with Section 13(k) of Securities Exchange Act of 1934 regarding loans to Directors and Senior Executives of a public company, the method comprising:
receiving one or more restricted shares of the equity security of the company, the one or more restricted shares having been awarded by the company to the one or more employee/participants of the Equity Based Incentive Compensation (EBIC) plan;
holding the one or more restricted shares in the holding vehicle on behalf of the one or more employee/participants;
receiving funds borrowed from a third party lender at the holding vehicle, the third party lender separate from the company and the holding vehicle, the borrowed funds secured by at least a portion of the one or more restricted shares being held in the holding vehicle;
using the borrowed funds to purchase one or more unrestricted shares of the equity security of the company; and
holding the one or more unrestricted shares along with the one or more restricted shares in the holding vehicle at least until the one or more restricted shares are taxable income to the employee/participant awarded the one or more restricted shares.

11. The method of claim 10, further comprising detecting the vesting of the one or more restricted shares of an employee/participant and whereby the share restrictions lift and the one or more shares become unrestricted, the vesting in accordance with a vesting schedule.

12. The method of claim 11, wherein the borrowed funds correspond to a loan from the third party lender, the loan corresponding to the employee/participant's portion of the one or more restricted shares, and further comprising:
receiving a loan repayment amount for the loan, the loan repayment amount including a principal loan repayment amount and an accrued interest repayment amount.

13. The method of claim 12, wherein a loan terms ends on or about the date vesting occurs for the collateral restricted shares of the loan, such that repayment of the loan repayment amount is triggered when the employee/participant's portion of the one or more restricted shares vests.

14. The method claim 12, further comprising:
receiving proceeds from selling at least one unrestricted share, the at least one unrestricted share selected from among: the one or more unrestricted shares and the further one or more unrestricted shares;
transferring at least a portion of the proceeds from the holding vehicle to the third party lender to repay the loan repayment amount.

15. The method of claim 13, further comprising:
calculating income tax liability for the employee/participant based on the value of a purchased share of the equity security at the date of its sale, based on the value of a share of the equity security when the one or more unrestricted shares were purchased, and based on the value of a share of the equity security at vesting, the calculated income tax liability having an ordinary income component and a long term capital gains component; and
computing the number of shares to equal the loan repayment and the income tax due on a disposition of the shares.

16. The method of claim 13, further comprising distributing to the employee/participant any remaining property, in the holding vehicle after vesting of restricted shares and the loan repayment collateralized by the unrestricted purchased and previously restricted shares.

17. The method of claim 10, wherein the holding vehicle is one of: a trust, a restricted brokerage account, a partnership, a managed account, or a limited liability company.

18. A system for establishing the Equity Based Incentive Compensation (EBIC) plan for a company and maintaining compliance with Regulation U of Title 12, Banks & Banking of the Code of Federal Regulations and with Section 13(k) of Securities Exchange Act of 1934 regarding loans to Directors and Senior Executives of a public company for the company, the system comprising:
one or more corporation computer systems for the corporation;
one or more holding vehicle computer systems for a holding vehicle, the holding vehicle configured to independently hold employer awarded restricted shares of equity securities of the company, the company having granted the restricted shares to one or more employee/participants of the Equity Based Incentive Compensation (EBIC) plan, the restricted shares having one or more restrictions prior to vesting; and
one or more third party lender computer systems for a third party lender, the third party lender separate from the company and the holding vehicle; and
wherein the one or more corporation computer systems include one or more computer storage devices having stored thereon computer-executable instructions that, when executed by a processor, cause the one or more corporation computer systems to:
deliver one or more restricted shares of an equity security of the company to the holding vehicle, the one or more restricted shares having been awarded by the company to the one or more employee/participants of the Equity Based Incentive Compensation (EBIC) plan;
receive a portion of borrowed funds from the holding vehicle for reimbursement of any payroll withholdings arising from employee elections to be taxed at the share award dates; and
send a registration statement for the one or more restricted shares to the third party lender;
wherein the one or more holding vehicle computer systems include one or more computer storage devices having stored thereon computer-executable instructions, that when executed by a processor, cause the one or more holding vehicle computer systems to:
receive the one or more restricted shares of the equity security of the company from the corporation;
receive elections from at least one employee/participant electing to include their portion of the one or more restricted shares as taxable income at the award date and without regard to the one or more restrictions; and
receive funds borrowed from the third party lender, the borrowed funds corresponding to a loan secured by at least a portion of the one or more restricted shares being held in the holding vehicle;
transfer the portion of borrowed funds to the company to reimburse payroll withholdings arising from the at least one employee/participant electing to be taxed at the share award dates; and
use another portion of the borrowed funds to purchase one or more unrestricted shared of the equity security of the company; and
wherein the one or more third party lender computer systems include one or more computer storage devices having stored thereon computer-executable instructions, that when executed by a processor, cause the one or more third party lender computer systems to:
transfer the borrowed funds to the holding vehicle;
receive the registration statement for the one or more restricted shares from the corporation;
borrow a number of shares up to the maximum number of shares indicated in registration statement; and
sell the borrowed shares to hedge against the collateral shares loss of value.

19. The system of claim 18, wherein the one or more holding vehicle computer systems include further computer-executable instructions, that when executed, cause the one or more holding vehicle computer systems to:
detect vesting of an employee/participant's portion of the one or more restricted shares into further one or more unrestricted shares, the vesting in accordance with a vesting schedule; and
indicate the detected vesting to the third party lender; and
wherein the one or more third party lender computer systems include further computer-executable instructions, that when executed, cause the one or more third party lender computer systems to:
receive the indication of detected vesting from the holding vehicle; and
determine a loan repayment amount for the loan in response to the detecting vesting, the loan repayment amount including a principal loan repayment amount and an accrued interest repayment amount; and
send the loan payment amount to the holding vehicle.

20. The system of claim 18, wherein the holding vehicle is one of: a trust, a restricted brokerage account, a partnership, a managed account, or a limited liability company.
